(19) United States
(12) Patent Application Publication
(10) Pub. No.: US 2022/0207790 A1
(43) Pub. Date: Jun. 30, 2022

(54) IMAGE GENERATION METHOD AND APPARATUS, AND COMPUTER

(71) Applicant: HUAWEI TECHNOLOGIES CO., LTD., Shenzhen (CN)

(72) Inventors: Huaming WU, Tianjin (CN); Jun WANG, Shenzhen (CN); Huabing LU, Shenzhen (CN)

(21) Appl. No.: 17/698,643

(22) Filed: Mar. 18, 2022

Related U.S. Application Data
(63) Continuation of application No. PCT/CN2020/110394, filed on Aug. 21, 2020.

(30) Foreign Application Priority Data
Sep. 18, 2019 (CN) 201910883761.9
Jul. 17, 2020 (CN) 202010695936.6

(51) Int. Cl. G06T 11/00; G06F 17/14; G06T 5/00

(52) U.S. Cl. CPC G06T 11/001; G06F 17/14; G06T 5/007; G06T 2207/20221; G06T 2207/20084; G06T 2207/20208; G06T 2207/20052

(57) ABSTRACT

This application discloses example image generation methods. One example method includes obtaining a target vector. The target vector can then be separately input to a first generator and a second generator to correspondingly generate a first sub-image and a second sub-image, where the first generator is obtained by a server by training, based on a low-frequency image and a first random noise variable that satisfies normal distribution, a first generative adversarial network (GAN), the second generator is obtained by the server by training, based on a high-frequency image and a second random noise variable that satisfies the normal distribution, a second GAN, and a frequency of the low-frequency image is lower than a frequency of the high-frequency image. The first sub-image and the second sub-image can then be synthesized to obtain a target image.

### CROSS-REFERENCE TO RELATED APPLICATIONS

This application is a continuation of International Patent Application No. PCT/CN2020/110394, filed on Aug. 21, 2020, which claims priorities to Chinese Patent Application No. 202010695936.6, filed on Jul. 17, 2020 and Chinese Patent Application No. 201910883761.9, filed on Sep. 18, 2019. All of the aforementioned patent applications are hereby incorporated by reference in their entireties.

### TECHNICAL FIELD

This application relates to the image processing field, and in particular, to an image generation method and apparatus, and a computer.

### BACKGROUND

Image generation is one of the most important research fields of computer vision, and is applied to image inpainting, image classification, virtual reality, and other related technologies. In terms of technical development of self-driving, diversity of generation scenarios and retention of objects in the scenarios are two different technical difficulties. One reason is that learning of mapping between various attribute variables and high-dimensional representations of images due to complexity of the scenarios is one of problems that have not been resolved in academia. The other reason is that pixels of images in outdoor scenarios are greatly changed due to illumination, scales, and blocking. Compared with robust recognition performance of humans, recognition performance of existing algorithms still needs to be greatly improved.

At present, an image generation technology has made some achievements in research of neural networks, especially has achieved best effect in a generative adversarial network (GAN). A GAN includes at least a generator and a discriminator. The generator is a network structure that uses a random noise variable to generate an image. Ideally, the generated image is very similar to a real image. The discriminator is a metric network used to distinguish the real image from the generated image. The GAN improves its performance through game learning between the generator and the discriminator, so that when performance meets a requirement, the generator can generate a high-quality image based on an input variable.

However, the biggest disadvantage of an existing generative adversarial network is instability of a generation process, which leads to poor quality of an image generated by the generative adversarial network.

### SUMMARY

Embodiments of this application provide an image generation method and apparatus, a computer, a storage medium, a chip system, and the like, to improve image generation quality by using a GAN technology.

According to a first aspect, this application provides an image generation method. The method may include: obtaining a target vector; separately inputting the target vector to a first generator and a second generator to correspondingly generate a first sub-image and a second sub-image, where the first generator is obtained by a server by training, based on a low-frequency image and a first random noise variable that satisfies normal distribution, an initially-configured first generative adversarial network GAN, the second generator is obtained by the server by training, based on a high-frequency image and a second random noise variable that satisfies normal distribution, an initially-configured second generative adversarial network GAN, and a frequency of the low-frequency image is lower than a frequency of the high-frequency image; and synthesizing the first sub-image and the second sub-image to obtain a target image.

In some possible implementations of the first aspect, the method may further include: obtaining the low-frequency image and the high-frequency image; obtaining the first random noise variable and the second random noise variable; setting the low-frequency image and the high-frequency image as training samples of the first GAN and the second GAN respectively; training the first GAN by using the low-frequency image and the first random noise variable to obtain the first generator; and training the second GAN by using the high-frequency image and the second random noise variable to obtain the second generator.

In some possible implementations of the first aspect, the obtaining the low-frequency image and the high-frequency image may include: obtaining an original image; and performing wavelet transform processing on the original image to obtain the low-frequency image and the high-frequency image. The synthesizing the first sub-image and the second sub-image to obtain a target image may include: synthesizing the first sub-image and the second sub-image through inverse wavelet transform processing to obtain the target image.

In some possible implementations of the first aspect, the performing wavelet transform processing on the original image to obtain the low-frequency image and the high-frequency image may include: performing discrete wavelet transform processing on the original image to obtain at least one low-frequency image and at least one high-frequency image that include K resolutions, where a Q^{th} resolution corresponds to M_{Q} low-frequency images and N_{Q} high-frequency images, K, M_{Q}, and N_{Q} are all positive integers, and Q=1, 2, 3, . . . , or K. The training the first GAN by using the low-frequency image and the first random noise variable to obtain the first generator may include: training S_{Q} initially-configured low-frequency GANs by using the M_{Q} low-frequency images at the Q^{th} resolution and the first random noise variable to obtain S_{Q} low-frequency generators, where S_{Q} is an integer greater than or equal to 1. The training the second GAN by using the high-frequency image and the second random noise variable to obtain the second generator may include: training W_{Q} initially-configured high-frequency GANs by using the N_{Q} high-frequency images at the Q^{th} resolution and the second random noise variable to obtain W_{Q} high-frequency generators, where W_{Q} is an integer greater than or equal to 1. The separately inputting the target vector to a first generator and a second generator to correspondingly generate a first sub-image and a second sub-image may include: separately inputting the target vector to Σ_{Q=1}^{K} S_{Q} low-frequency generators and Σ_{Q=1}^{K} W_{Q} high-frequency generators to obtain Σ_{Q=1}^{K} S_{Q} low-frequency generation sub-images and Σ_{Q=1}^{K} W_{Q} high-frequency generation sub-images. The synthesizing the first sub-image and the second sub-image through inverse wavelet transform processing to obtain the target image may include: synthesizing the Σ_{Q=1}^{K} S_{Q} low-frequency generation sub-images and the Σ_{Q=1}^{K} W_{Q} high-frequency generation sub-images through inverse discrete wavelet transform processing to obtain the target image.

In some possible implementations of the first aspect, in a process of training any generator, the method further includes: using output of any other one or more generators as input to the generator, where the any other one or more generators include any one or more generators other than the generator in the low-frequency generators and the high-frequency generators.

In some possible implementations of the first aspect, the first random noise variable and the second random noise variable are orthogonal.

In some possible implementations of the first aspect, the M_{Q} low-frequency images may include a first low-frequency image, and the N_{Q} high-frequency images may include a first high-frequency image, a second high-frequency image, and a third high-frequency image. The first low-frequency image may include low-frequency information of the original image in a vertical direction and a horizontal direction, the first high-frequency image may include low-frequency information of the original image in the vertical direction and high-frequency information of the original image in the horizontal direction, the second high-frequency image may include high-frequency information of the original image in the vertical direction and low-frequency information of the original image in the horizontal direction, and the third high-frequency image may include high-frequency information of the original image in the vertical direction and high-frequency information of the original image in the horizontal direction. The training S_{Q} initially-configured low-frequency GANs by using the M_{Q} low-frequency images at the Q^{th} resolution and the first random noise variable to obtain S_{Q} low-frequency generators includes: training a first low-frequency GAN by using the M_{Q} low-frequency images at the Q^{th} resolution and the first random noise variable to obtain a Q^{th} low-frequency generator. The training W_{Q} initially-configured high-frequency GANs by using the N_{Q} high-frequency images at the Q^{th} resolution and the second random noise variable to obtain W_{Q} high-frequency generators includes: training a Q^{th} initially-configured first high-frequency GAN by using the first high-frequency image at the Q^{th} resolution and a third random noise variable to obtain a Q^{th} first high-frequency generator; training a Q^{th} initially-configured second high-frequency GAN by using the second high-frequency image at the Q^{th} resolution and a fourth random noise variable to obtain a Q^{th} second high-frequency generator; and training a Q^{th} initially-configured third high-frequency GAN by using the third high-frequency image at the Q^{th} resolution and a fifth random noise variable to obtain a Q^{th} third high-frequency generator. The separately inputting the target vector to Σ_{Q=1}^{K} S_{Q} low-frequency generators and Σ_{Q=1}^{K} W_{Q} high-frequency generators to obtain Σ_{Q=1}^{K} S_{Q} low-frequency generation sub-images and Σ_{Q=1}^{K} W_{Q} high-frequency generation sub-images includes: separately inputting the target vector to K low-frequency generators, K first high-frequency generators, K second high-frequency generators, and K third high-frequency generators, to obtain K low-frequency generation sub-images, K first high-frequency generation sub-images, K second high-frequency generation sub-images, and K third high-frequency generation sub-images. The synthesizing the Σ_{Q=1}^{K} S_{Q} low-frequency generation sub-images and the Σ_{Q=1}^{K} W_{Q} high-frequency generation sub-images through inverse discrete wavelet transform processing to obtain the target image includes: synthesizing the K low-frequency generation sub-images, the K first high-frequency generation sub-images, the K second high-frequency generation sub-images, and the K third high-frequency generation sub-images through inverse discrete wavelet transform processing to obtain the target image.

In some possible implementations of the first aspect, the method further includes: obtaining an original image; and performing discrete cosine transform processing on the original image to obtain the low-frequency image and the high-frequency image. The synthesizing the first sub-image and the second sub-image to obtain a target image may include: synthesizing the first sub-image and the second sub-image through inverse discrete cosine transform processing to obtain the target image.

In some possible implementations of the first aspect, the method further includes: obtaining an original image; and performing Fourier transform processing on the original image to obtain the low-frequency image and the high-frequency image. The synthesizing the first sub-image and the second sub-image to obtain a target image may include: synthesizing the first sub-image and the second sub-image through Fourier transform processing to obtain the target image.

In some possible implementations of the first aspect, the method further includes: superimposing the target image on an image generated by another generator to obtain a final target image, where superimposition may be a weighted combination. It should be noted that the another generator may be any generator in the conventional technology, and the generator also participates in a training process. A weight adjustment factor α can be self-learned based on a dataset, and a value of a varies depending on different datasets in different scenarios.

According to a second aspect, this application provides an image generation apparatus. The apparatus may be a computer, and the computer may be a terminal device or a server. For example, the computer may be a device having a high requirement on image quality, such as a smartphone, a smart television (or referred to as a smart screen), a virtual reality device, an augmented reality device, a mixed reality device, or an in-vehicle device (including a device used for assisted driving and unmanned driving). The apparatus may also be considered as a software program, and the software program is executed by one or more processors to implement functions. The apparatus may also be considered as hardware, and the hardware includes a plurality of functional circuits configured to implement functions. The apparatus may also be considered as a combination of a software program and hardware.

The apparatus includes: a transceiver unit, configured to obtain a target vector; and a processing unit, configured to: separately input the target vector to a first generator and a second generator to correspondingly generate a first sub-image and a second sub-image, where the first generator is obtained by the computer by training, based on a low-frequency image and a first random noise variable that satisfies normal distribution, an initially-configured first generative adversarial network GAN, the second generator is obtained by the computer by training, based on a high-frequency image and a second random noise variable that satisfies normal distribution, an initially-configured second generative adversarial network GAN, and a frequency of the low-frequency image is lower than a frequency of the high-frequency image; and synthesize the first sub-image and the second sub-image to obtain a target image.

In some possible implementations of the second aspect, the transceiver unit is further configured to obtain the low-frequency image, the high-frequency image, the first random noise variable, and the second random noise variable. The processing unit is further configured to: set the low-frequency image and the high-frequency image as training samples of the first GAN and the second GAN respectively, train the first GAN by using the low-frequency image and the first random noise variable to obtain the first generator, and train the second GAN by using the high-frequency image and the second random noise variable to obtain the second generator.

In some possible implementations of the second aspect, the transceiver unit is specifically configured to obtain an original image. The processing unit is specifically configured to: perform wavelet transform processing on the original image to obtain the low-frequency image and the high-frequency image, and synthesize the first sub-image and the second sub-image through inverse wavelet transform processing to obtain the target image.

In some possible implementations of the second aspect, the processing unit is specifically configured to: perform discrete wavelet transform processing on the original image to obtain at least one low-frequency image and at least one high-frequency image that include K resolutions, where a Q^{th} resolution corresponds to M_{Q} low-frequency images and N_{Q} high-frequency images, K, M_{Q}, and N_{Q} are all positive integers, and Q=1, 2, 3, . . . , or K; train S_{Q} initially-configured low-frequency GANs by using the M_{Q} low-frequency images at the Q^{th} resolution and the first random noise variable to obtain S_{Q} low-frequency generators, where S_{Q} is an integer greater than or equal to 1; train W_{Q} initially-configured high-frequency GANs by using the N_{Q} high-frequency images at the Q^{th} resolution and the second random noise variable to obtain W_{Q} high-frequency generators, where W_{Q} is an integer greater than or equal to 1; separately input the target vector to Σ_{Q=1}^{K} S_{Q} low-frequency generators and Σ_{Q=1}^{K} W_{Q} high-frequency generators to obtain Σ_{Q=1}^{K} S_{Q} low-frequency generation sub-images and Σ_{Q=1}^{K} W_{Q} high-frequency generation sub-images; and synthesize the Σ_{Q=1}^{K} S_{Q} low-frequency generation sub-images and the Σ_{Q=1}^{K} W_{Q} high-frequency generation sub-images through inverse discrete wavelet transform processing to obtain the target image.

In some possible implementations of the second aspect, in a process of training any one generator, the processing unit is configured to use output of any other one or more generators as input to the generator, where the any other one or more generators include any one or more generators other than the generator in the low-frequency generators and the high-frequency generators.

In some possible implementations of the second aspect, the first random noise variable and the second random noise variable are orthogonal.

In some possible implementations of the second aspect, the M_{Q} low-frequency images may include a first low-frequency image, and the N_{Q} high-frequency images may include a first high-frequency image, a second high-frequency image, and a third high-frequency image. The first low-frequency image may include low-frequency information of the original image in a vertical direction and a horizontal direction, the first high-frequency image may include low-frequency information of the original image in the vertical direction and high-frequency information of the original image in the horizontal direction, the second high-frequency image may include high-frequency information of the original image in the vertical direction and low-frequency information of the original image in the horizontal direction, and the third high-frequency image may include high-frequency information of the original image in the vertical direction and high-frequency information of the original image in the horizontal direction. The processing unit is specifically configured to: train a first low-frequency GAN by using the M_{Q} low-frequency images at the Q^{th} resolution and the first random noise variable to obtain a Q^{th} low-frequency generator; train a Q^{th} initially-configured first high-frequency GAN by using the first high-frequency image at the Q^{th} resolution and a third random noise variable to obtain a Q^{th} first high-frequency generator; train a Q^{th} initially-configured second high-frequency GAN by using the second high-frequency image at the Q^{th} resolution and a fourth random noise variable to obtain a Q^{th} second high-frequency generator; train a Q^{th} initially-configured third high-frequency GAN by using the third high-frequency image at the Q^{th} resolution and a fifth random noise variable to obtain a Q^{th} third high-frequency generator; separately input the target vector to K low-frequency generators, K first high-frequency generators, K second high-frequency generators, and K third high-frequency generators, to obtain K low-frequency generation sub-images, K first high-frequency generation sub-images, K second high-frequency generation sub-images, and K third high-frequency generation sub-images; and synthesize the K low-frequency generation sub-images, the K first high-frequency generation sub-images, the K second high-frequency generation sub-images, and the K third high-frequency generation sub-images through inverse discrete wavelet transform processing to obtain the target image.

In some possible implementations of the second aspect, the transceiver unit is specifically configured to obtain an original image. The processing unit is specifically configured to: perform discrete cosine transform processing on the original image to obtain the low-frequency image and the high-frequency image, and synthesize the first sub-image and the second sub-image through inverse discrete cosine transform processing to obtain the target image.

In some possible implementations of the second aspect, the transceiver unit is specifically configured to obtain an original image. The processing unit is specifically configured to: perform Fourier transform processing on the original image to obtain the low-frequency image and the high-frequency image, and synthesize the first sub-image and the second sub-image through Fourier transform processing to obtain the target image.

In some possible implementations of the second aspect, the method further includes a superimposition unit, where the superimposition unit is configured to superimpose the target image on an image generated by another generator to obtain a final target image, and superimposition may be a weighted combination. It should be noted that the another generator may be any generator in the conventional technology, and the generator also participates in the training process.

A third aspect of embodiments of this application provides a computer for image generation, and the computer may include a processor, a memory, and a transceiver. The transceiver is configured to communicate with an apparatus other than the computer. The memory is configured to store instruction code. When the processor executes the instruction code, the computer is enabled to perform the method according to any one of the first aspect or the implementations of the first aspect.

A fourth aspect of embodiments of this application provides a computer storage medium. The medium stores instructions, and when the instructions are run on a computer, the computer is enabled to perform the method according to any one of the first aspect or the implementations of the first aspect.

A fifth aspect of embodiments of this application provides a computer program product. The computer program product may include instructions, and when the instructions are run on a computer, the computer is enabled to perform the method according to any one of the first aspect or the implementations of the first aspect.

A sixth aspect of embodiments of this application provides a chip system, including an interface and a processing circuit. The chip system obtains a software program through the interface, and executes the software program and implements the method according to any one of the first aspect or the implementations of the first aspect through the processing circuit.

A seventh aspect of embodiments of this application provides a chip system, including one or more functional circuits. The one or more functional circuits are configured to implement the method according to any one of the first aspect or the possible implementations of the first aspect.

It can be learned from the foregoing technical solutions that embodiments of this application have the following advantages:

After obtaining the first generator and the second generator through training, the computer separately inputs the target vector to the first generator and the second generator, to correspondingly generate the first sub-image and the second sub-image. Then, the first sub-image and the second sub-image are synthesized to obtain the target image. Because the first generator is obtained by training the initially-configured first GAN in advance by using the first random noise variable and the low-frequency image, and the second generator is obtained by training the initially-configured second GAN in advance by using the second random noise variable and the high-frequency image, the correspondingly generated first sub-image and second sub-image are also a low-frequency image and a high-frequency image respectively. It should be noted that, based on definition of a frequency of an image, the high-frequency image may better reflect detail information of the image, for example, contour information of each subject feature in the image, and low-frequency image may better reflect main information of the image, for example, information such as a grayscale and a color of the image. In the solutions, the low-frequency image and the high-frequency image are separately generated, so that detail information and main information of the to-be-generated target image can be better retained in a process of generating the target image. In this way, better quality of the generated target image is ensured.

### BRIEF DESCRIPTION OF DRAWINGS

To describe the technical solutions in embodiments of this application or in the conventional technology more clearly, the following briefly describes the accompanying drawings for describing embodiments or the conventional technology. It is clear that the accompanying drawings in the following description show merely some embodiments of this application, and a person of ordinary skill in the art may still derive other drawings from these accompanying drawings without creative efforts.

FIG. 1 is a schematic diagram of a structure of an existing generative adversarial network;

FIG. 2 is a schematic flowchart of generating an image by using a GAN technology in the conventional technology;

FIG. 3 is a schematic diagram of a structure of an existing convolutional neural network;

FIG. 4 is a schematic diagram of another structure of an existing convolutional neural network;

FIG. 5 is a schematic diagram of an embodiment of an image generation method according to an embodiment of this application;

FIG. 6 is a schematic diagram of an embodiment of a system architecture according to an embodiment of this application;

FIG. 7A and FIG. 7B are a schematic diagram of another embodiment of an image generation method according to an embodiment of this application;

FIG. 8 is a schematic diagram of an embodiment of another system architecture according to an embodiment of this application;

FIG. 9 is a schematic diagram of an embodiment of a server according to an embodiment of this application; and

FIG. 10 is a schematic diagram of another embodiment of a server according to an embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application. All other embodiments obtained by a person of ordinary skill in the art based on embodiments of this application without creative efforts shall fall within the protection scope of this application.

In recent years, artificial intelligence and deep learning have become familiar terms. Generally, deep learning models may be classified into a discriminative model and a generative model. Due to invention of algorithms such as a back propagation (back propagation, BP) algorithm and a random dropout (dropout) algorithm, the discriminative model develops rapidly. However, due to difficulty in modeling of the generative model, development of the generative model is slow. This field rejuvenates until a GAN was invented in recent years. With rapid development of theories and models of the GAN, the GAN has been used in computer vision, natural language processing, human-computer interaction, and other fields, and is extending to other fields.

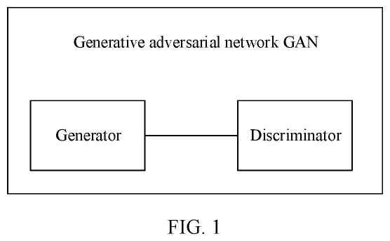

As shown in FIG. 1, FIG. 1 is a schematic diagram of a structure of a GAN. A basic structure of the GAN includes a generator and a discriminator. In a GAN technology inspired by a zero-sum game in a game theory, a generative problem is considered as an adversarial game between the two networks, namely, the discriminator and the generator. To be specific, the generator uses given noise (generally, the noise is uniformly distributed or normally distributed) to generate synthetic data, and the discriminator distinguishes output of the generator from real data. The former tries to generate data closer to real data; and accordingly the latter tries to more perfectly distinguish the real data from the generated data. In this way, the two networks progress in adversary, and continue contesting with each other after progress. Data obtained by the generator becomes more and more perfect and approximates the real data, so that desired data (a picture, a sequence, video, and the like) may be generated.

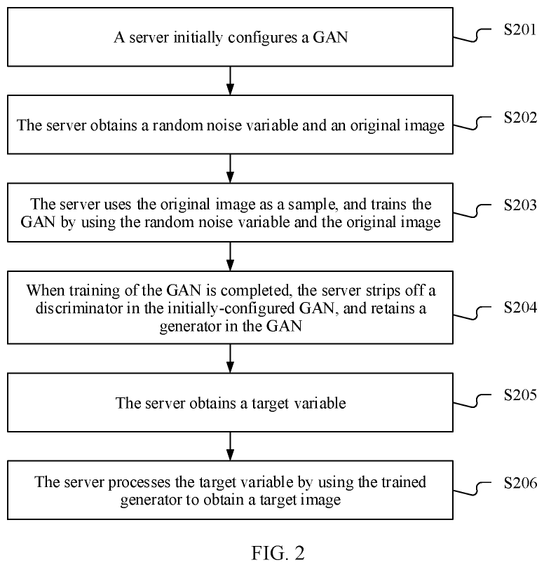

Specifically, an example in which the GAN is used in the image processing field is used for description. In the conventional technology, for a procedure of generating an image by using the GAN technology, refer to a schematic flowchart shown in FIG. 2. The following briefly describes the steps.

S201: A server initially configures a GAN: When a GAN is used to generate an image, the GAN needs to be first initially configured on the server. A generator and a discriminator in the initially-configured GAN may be weak, and need to be trained.

S202: The server obtains a random noise variable and an original image: After the GAN is initially configured on the server, at least one random noise variable and at least one original image may be input to the GAN.

S203: The server uses the original image as a training sample, and trains the GAN by using the random noise variable and the original image: After obtaining the random noise variable and the original image, the server sets the original image as the training sample of the initially-configured GAN, and uses the generator in the GAN to convert the random noise variable into a generated image for deceiving the discriminator. Then, the server randomly selects an image from the original image and the generated image as input, and transmits the image to the discriminator. The discriminator is essentially similar to a two-classifier. After receiving the image transmitted by the generator, the discriminator identifies the received image, determines whether the image is the original image or the image generated by the generator, and obtains a value of probability that the image is the original image. Each time the value of probability is obtained through calculation, the GAN may calculate, based on the value of probability, loss functions (loss functions) corresponding to the generator and the discriminator, perform gradient back propagation by using a back propagation algorithm, and sequentially update parameters of the discriminator and the generator according to the loss functions. Specifically, when the discriminator and the generator are updated, an update policy of alternative iteration is used. To be specific, the generator is first fixed, and the parameters of the discriminator are updated. Then, the discriminator is fixed next time, and the parameters of the generator are updated. After the parameters of the discriminator and generator are updated, a “forgery” capability of the generator and a “forgery identification” capability of the discriminator can be further improved. The GAN cyclically performs a “generate-discriminate-update” process for a plurality of times, so that the discriminator can finally accurately determine whether an image is the original image. In addition, the generator approximates a probability distribution function of the original image by using a probability distribution function of the image generated based on the first random noise variable. In this case, the discriminator cannot determine whether the image transferred by the discriminator is true or false, in other words, Nash equilibrium between the generator and the discriminator is finally implemented. When Nash equilibrium is implemented, training of the GAN is completed.

S204: When the training of the GAN is completed, the server strips off the discriminator in the initially-configured GAN, and retains the generator in the GAN: When the training of the GAN is completed, the generator in the initially-configured GAN meets a specified performance requirement. In this case, the server may strip off the discriminator network in the GAN, and reserve the generator in the GAN as an image generation model.

S205: The server obtains a target variable: After the server trains the GAN to obtain a trained generator, the server obtains the target vector when a target image needs to be generated.

S206: The server processes the target vector by using the trained generator to obtain the target image. After obtaining the target variable, the server inputs the target vector to the generator, and the generator performs processing to generate the target image. In an actual application, the target vector may be a random noise variable obtained by the server from external input or generated by the server, or may be a specific variable that includes image feature information that needs to be generated. Specifically, for example, the original image includes a plurality of scenery images in reality. If the target vector target vector is the random noise variable, a finally output target image may be a synthesized image whose style is similar to that of the original image. If the target vector target vector includes the image feature information that needs to be generated (for example, image elements need to include mountains and contour information of the mountains), the finally output target image may be a synthesized image that includes the image feature information and whose style is similar to that of the original image.

In an earliest GAN theory, the generator and discriminator do not need to be neural networks, but need to be able to fit corresponding generative and discriminant functions. However, with development of the GAN, networks of the generator and the discriminator are mostly implemented in neural networks due to a good fitting ability and a good expression ability of the neural network. Specifically, when the GAN is used for an image, an improved stronger model for the GAN is a deep convolutional adversarial neural network (deep convolutional generative adversarial network, DCGAN). A neural network used by a discriminator in the DCGAN is a convolutional neural network (convolutional neural network, CNN), and a neural network used by a generator in the DCGAN is a de-CNN.

The convolutional neural network used by the discriminator is a deep neural network with a convolutional structure, and is a deep learning (deep learning) architecture. The deep learning architecture means that a plurality of levels of learning are performed at different abstraction levels by using a machine learning algorithm. As the deep learning architecture, the CNN is a feed-forward (feed-forward) artificial neural network. Neurons in the feed-forward artificial neural network respond to an overlapping region in an image input to the CNN.

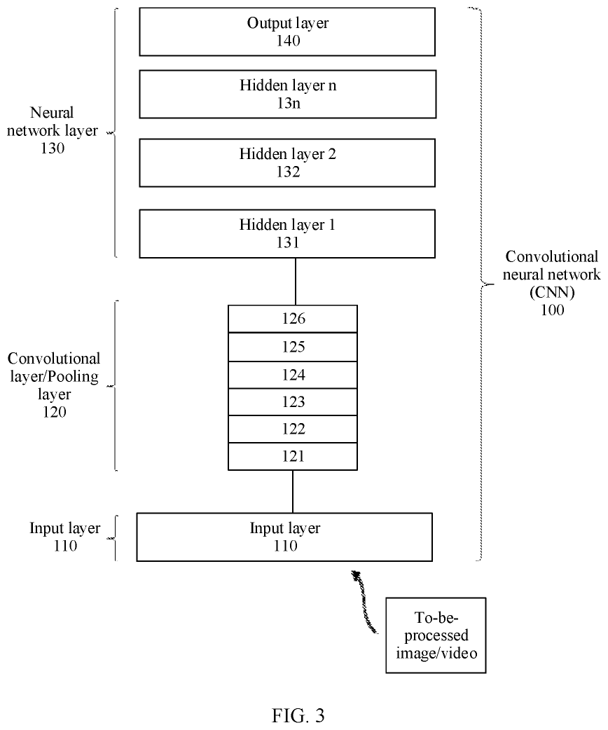

As shown in FIG. 3, a convolutional neural network (CNN) 100 may include an input layer 110, a convolutional layer/pooling layer 120, and a neural network layer 130. The pooling layer is optional.

Convolutional Layer/Pooling Layer 120:

As shown in FIG. 3, for example, the convolutional layer/pooling layer 120 may include layers 121 to 126. In an implementation, the layer 121 is a convolutional layer, the layer 122 is a pooling layer, the layer 123 is a convolutional layer, the layer 124 is a pooling layer, the layer 125 is a convolutional layer, and the layer 126 is a pooling layer. In another implementation, the layer 121 and the layer 122 are convolutional layers, the layer 123 is a pooling layer, the layer 124 and the layer 125 are convolutional layers, and the layer 126 is a pooling layer. In other words, output of a convolutional layer may be used as input for a subsequent pooling layer, or may be used as input for another convolutional layer, to continue to perform a convolution operation.

The convolutional layer 121 is used as an example. The convolutional layer 121 may include a plurality of convolution operators. The convolution operator is also referred to as a kernel. In image processing, the convolution operator functions as a filter that extracts specific information from an input image matrix. The convolution operator may essentially be a weight matrix, and the weight matrix is usually predefined. In a process of performing a convolution operation on an image, the weight matrix is usually used to process pixels at a granularity level of one pixel (or two pixels, depending on a value of a stride (stride)) in a horizontal direction on the input image, to extract a specific feature from the image. A size of the weight matrix needs to be related to a size of the image. It should be noted that a depth dimension (depth dimension) of the weight matrix is the same as a depth dimension of the input image. During a convolution operation, the weight matrix extends to an entire depth of the input image. Therefore, convolution output of a single depth dimension is generated by performing convolution with a single weight matrix. However, in most cases, a plurality of weight matrices of a same dimension rather than the single weight matrix are used. Output of the weight matrices is stacked to form a depth dimension of a convolutional image. Different weight matrices may be used to extract different features from the image. For example, one weight matrix is used to extract edge information of the image, another weight matrix is used to extract a specific color of the image, still another weight matrix is used to blur unnecessary noises in the image, and so on. Because the plurality of weight matrices have the same dimension, feature maps extracted by using the plurality of weight matrices also have a same dimension. Then, the plurality of extracted feature maps with the same dimension are combined to form output of the convolution operation.

Weight values in these weight matrices need to be obtained in an actual application through massive training. The weight matrices that are formed based on the weight values obtained through training may be used to extract information from the input image, to help the convolutional neural network 100 perform correct prediction.

When the convolutional neural network 100 includes a plurality of convolutional layers, a larger quantity of general features are usually extracted at an initial convolutional layer (for example, the convolutional layer 121). The general features may also be referred to as low-level features. As a depth of the convolutional neural network 100 increases, a feature extracted at a more subsequent convolutional layer (for example, the convolutional layer 126) is more complex, for example, a high-level semantic feature. A feature with higher semantics is more applicable to a to-be-resolved problem.

Pooling Layer:

Because a quantity of training parameters usually needs to be reduced, a pooling layer usually needs to be periodically introduced after a convolutional layer. To be specific, for the layers 121 to 126 in the convolutional layer/pooling layer 120 shown in FIG. 3, one convolutional layer may be followed by one pooling layer, or a plurality of convolutional layers may be followed by one or more pooling layers. During image processing, the pooling layer is only used to reduce a space size of the image. The pooling layer may include an average pooling operator and/or a maximum pooling operator, to perform sampling on the input image to obtain an image with a relatively small size. The average pooling operator may calculate a pixel value in the image within a specific range, to generate an average value. The maximum pooling operator may be used to select a pixel with a maximum value within a specific range as a maximum pooling result. In addition, just as the size of the weight matrix needs to be related to the size of the image at the convolutional layer, an operator also needs to be related to a size of an image at the pooling layer. A size of a processed image output from the pooling layer may be less than a size of an image input to the pooling layer. Each pixel in the image output from the pooling layer represents an average value or a maximum value of a corresponding sub-region of the image input to the pooling layer.

Neural Network Layer 130:

After processing is performed at the convolutional layer/pooling layer 120, the convolutional neural network 100 still cannot output required output information. As described above, at the convolutional layer/pooling layer 120, only a feature is extracted, and parameters resulting from an input image are reduced. However, to generate final output information (required type information or other related information), the convolutional neural network 100 needs to use the neural network layer 130 to generate output of one required type or one group of required types. Therefore, the neural network layer 130 may include a plurality of hidden layers (layers 131, 132, . . . , and 13n shown in FIG. 3) and an output layer 140. The plurality of hidden layers are also referred to as fully-connected layers, and parameters included in the plurality of hidden layers may be obtained through pre-training based on related training data of a specific task type. For example, the task type may include image recognition, image classification, and super-resolution image reconstruction.

The plurality of hidden layers included in the neural network layer 130 are followed by the output layer 140, namely, the last layer of the entire convolutional neural network 100. The output layer 140 has a loss function similar to a categorical cross entropy, and the loss function is specifically used to calculate a prediction error. Once forward propagation (for example, propagation from the layers 110 to 140 in FIG. 3 is forward propagation) of the entire convolutional neural network 100 is completed, reverse propagation (for example, propagation from the layers 140 to 110 in FIG. 3 is reverse propagation) is started to update weight values of the layers and a deviation mentioned above, to reduce a loss of the convolutional neural network 100 and an error between a result output by the convolutional neural network 100 by using the output layer and an ideal result.

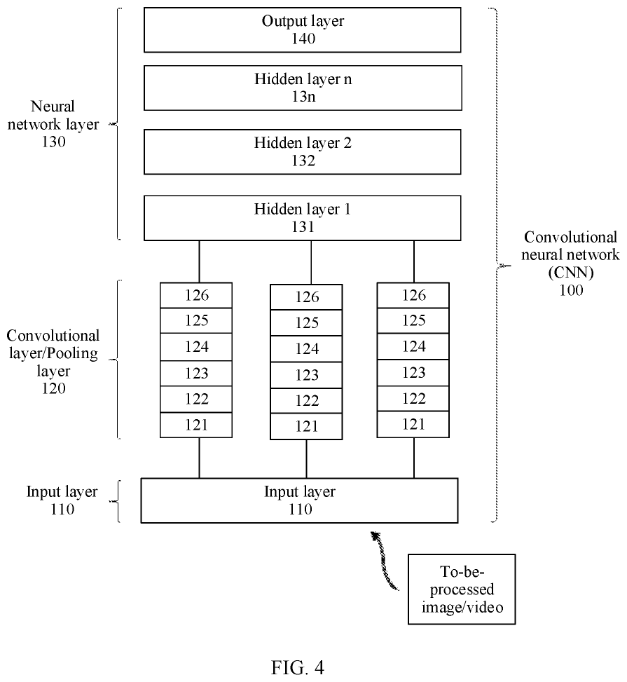

It should be noted that the convolutional neural network 100 shown in FIG. 3 is merely used as an example of a convolutional neural network. In a specific application, the convolutional neural network may alternatively exist in a form of another network model, for example, a network model in which a plurality of convolutional layers/pooling layers are parallel as shown in FIG. 4, and extracted features are all input to the neural network layer 130 for processing.

The generator corresponds to the discriminator, and uses a de-convolutional neural network. In the de-convolutional neural network of the generator, a de-convolutional operation, or referred to as a transposed convolutional operation, is performed.

The foregoing briefly describes a current process of generating an image by using the GAN technology. It can be learned that when the GAN is used to generate the image, two processes of training and using the GAN may be included. However, currently, when image processing is performed by using the GAN technology, quality of a generated target image usually cannot be ensured due to difficulty in training the deep neural network and instability of a training process.

Based on the foregoing description, this application provides an image generation method, to generate a high-quality image. Specifically, after obtaining a first generator and a second generator through training, the server separately inputs the target vector target vector to the first generator and the second generator, to correspondingly generate a first sub-image and a second sub-image. Because the first generator is obtained by training an initially-configured first GAN in advance by using the first random noise variable and a low-frequency image, and the second generator is obtained by training an initially-configured second GAN in advance by using a second random noise variable and a high-frequency image, the correspondingly generated first sub-image and second sub-image are also a low-frequency image and a high-frequency image respectively. Then, the first sub-image and the second sub-image are synthesized to obtain the target image.

It should be noted that a frequency of an image, also referred to as a spatial frequency of the image, is a quantity of gate cycles for sinusoidal modulation based on bright and dark of an image or a stimulus graph in each degree of angle of view. A unit is cycle/degree, and the frequency reflects a change of a pixel grayscale of the image in space. Specifically, if a grayscale value of an image, for example, an image on a wall, is evenly distributed, a low-frequency component of the image is relatively strong, and a high-frequency component of the image is relatively weak; and if a grayscale value of an image, for example, an image of a satellite map of ravines, changes drastically, a high-frequency component of the image is relatively strong, and a low-frequency component of the image is relatively weak. Therefore, the low-frequency image can better reflect main information of the image, for example, colors and grayscale information of main features in the image, and the high-frequency image can better reflect detail information of the image, for example, contour edge information of each main feature in the image. Therefore, the first sub-image and the second sub-image are generated and then synthesized, so that main information and detail information of the target image can be better stored, and quality of the generated target image is better.

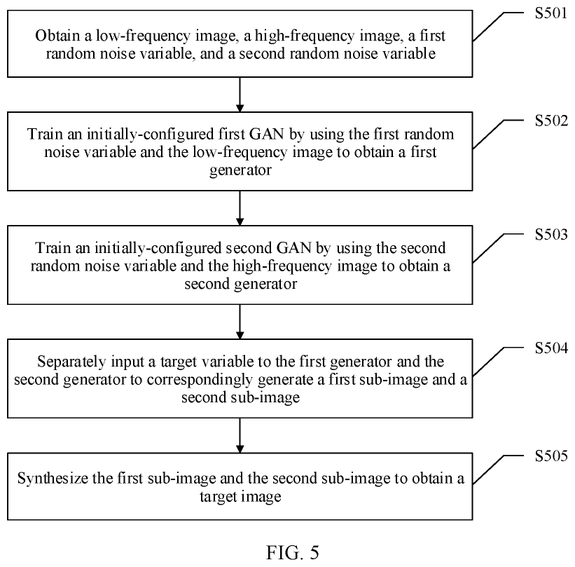

FIG. 5 is a schematic diagram of an embodiment of an image generation method according to an embodiment of this application, including the following steps:

S501: A server obtains a low-frequency image, a high-frequency image, a first random noise variable, and a second random noise variable.

In a specific embodiment, a first GAN and a second GAN are initially configured on the server. Before the first GAN and the second GAN are trained, at least one low-frequency image, at least one high-frequency image, the first random noise variable, and the second random noise variable need to be obtained. A frequency of the high-frequency image is higher than a frequency of the low-frequency image, and variable lengths of the first random noise variable and the second random noise variable may be the same and both meet normal distribution. The low-frequency image and the high-frequency image may be input by an external device, or may be obtained by the server by decomposing an obtained original image. When the original image is decomposed, one original image may be decomposed into one or more low-frequency images and high-frequency images.

It should be noted that “first”, “second”, and the like in this application are merely intended to distinguish concepts, but do not limit a sequence. Sometimes, based on a context, “first” may include “second” and “third”, or another similar case. In addition, concepts modified by “first” and “second” are not limited to only one, and may be one or more.

In the foregoing process, the described obtained image includes the low-frequency image and the high-frequency image. However, it should be noted a case in which there are only images of two frequencies is not limited herein. In an actual application, more frequency types may be set based on a requirement. For example, the image may be further classified into the low-frequency image, an intermediate-frequency image, and the high-frequency image, and three frequencies are in ascending order. Four, five, or more types may be further set, which may be specifically preset.

In a specific embodiment, the server obtains the original image, and performs a decomposition operation on the original image, to obtain the at least one low-frequency image and the at least one high-frequency image that correspond to the original image.

In a specific embodiment, after obtaining the original image, the server may decompose the original image to obtain the at least one low-frequency image and the at least one high-frequency image that correspond to the original image. There may be a plurality of manners used for high-decomposition of the original image, for example, Fourier transform, discrete cosine transform, and wavelet transform, but this is not limited thereto. In this application, another method may be used to decompose the original image. A quantity of low-frequency images and a quantity of high-frequency images obtained through decomposition, and frequencies of the low-frequency images and the high-frequency images may be preset. Setting of specific quantities and frequencies is not limited in this embodiment.

In a specific embodiment, a quantity of initially-configured GANs on the server is related to a quantity of preset types of resolutions and/or image frequencies, and may be specifically K=P*Q, where K is the quantity of initially-configured GANs, P is the quantity of types of the resolutions, and Q is the quantity of types of the image frequencies. Therefore, when the original image is decomposed, division may be performed based on preset resolutions and image frequencies.

S502: The server trains an initially-configured first GAN by using the first random noise variable and the low-frequency image to obtain a first generator.

In a specific embodiment, the server sets the low-frequency image as a training sample of the first GAN, and inputs the first random noise variable to the first GAN to train the first GAN. Specifically, a process of training the first GAN is similar to related description in step S203 in FIG. 2, and details are not described herein again.

When training is completed, the server strips off a discriminator in the first GAN, and retains a generator in the first GAN, where the generator is the first generator.

S503: The server trains an initially-configured second GAN by using the second random noise variable and the high-frequency image to obtain a second generator. It should be noted that the second random noise variable and the first random noise variable need to be orthogonal.

In a specific embodiment, the server sets the high-frequency image as a real image of the second GAN, in other words, uses the high-frequency image as a training sample of the second GAN; and inputs the second random noise variable to the second GAN to train the second GAN. Specifically, a process of training the second GAN is similar to related description in step S203 in FIG. 2, and details are not described herein again.

When training is completed, the server strips off a discriminator in the second GAN, and retains a generator in the second GAN, where the generator is the second generator.

In a specific embodiment, after obtaining the original image, and when decomposing the original image, the server may decompose the original image through discrete wavelet change processing to obtain the at least one low-frequency image and the at least one high-frequency image that include K resolutions. The K resolutions decrease sequentially, a Q^{th} resolution corresponds to M_{Q} low-frequency images and N_{Q} high-frequency images, K, M_{Q}, and N_{Q} are all positive integers, and Q=1, 2, 3 . . . , or K. Values of M_{Q} and N_{Q} may be the same or may be different at different resolutions. This is specifically preset by a user.

The following uses a training process at the Q^{th} resolution as an example for description. For another resolution, refer to the example.

After obtaining the M_{Q} low-frequency images and the N_{Q} high-frequency images at the Q^{th} resolution, the server first trains S_{Q} initially-configured low-frequency GANs by using the first random noise variable (for example, M_{Q} random noise variables) and the M_{Q} low-frequency images; and obtains S_{Q} low-frequency generators when training is completed. The server trains W_{Q} initially-configured high-frequency GANs by using the second random noise variable (for example, N_{Q} random noise variables) and the N_{Q} high-frequency images; and obtains W_{Q} high-frequency generators when training is completed.

It should be noted that both S_{Q} and W_{Q} are integers greater than or equal to 1, and values of S_{Q} and W_{Q} may be the same or may be different. For example, at a resolution, there may be one low-frequency GAN and one high-frequency GAN, to obtain one low-frequency generator and one high-frequency generator. For another example, at a resolution, there may be any plurality of low-frequency GANs and any plurality of high-frequency GANs, to obtain any plurality of corresponding low-frequency generators and any plurality of corresponding high-frequency generators.

In the training process, the S_{Q} low-frequency generators and the W_{Q} high-frequency generators are not completely independent, and output of each generator may be used as input information of another generator. For example, in a first iteration, input to the first low-frequency generator includes only random noise, input to the second low-frequency generator includes output of the first low-frequency generator and random noise, and input to the third low-frequency generator includes random noise and output of the first and second generators. The rest may be deduced by analogy. Input to an S_{Q}^{th} low-frequency generator includes random noise and output of previous S_{Q}−1 low-frequency generators. The rest continues to be deduced by analogy. Input to the first high-frequency generator includes random noise and the output of the previous S_{Q}−1 low-frequency generators; and input to a W_{Q}^{th} high-frequency generator includes random noise and output of previous S_{Q}+W_{Q}−1 generators (including the low-frequency generators and high-frequency generators).

Similarly, in the second iteration, input to each generator (regardless that the generator is a high-frequency generator or a low-frequency generator) is random noise and output of previous generators. Iteration is continued for a plurality of times.

In another embodiment, when output of previous generators is selected as input to a current generator, output of any one or more previous generators may be selected instead of output of all previous generators as in this embodiment. Specific generators to be selected may be set based on a specific requirement, and are not limited in this application.

In addition, random noise variables input by all the foregoing generators in the training process need to be orthogonal, and orthogonalization processing needs to be performed on the random noise variables by using an orthogonalization technology, to ensure independence of the random noise variables.

The foregoing is the training process at the Q^{th} resolution. For other resolutions, refer to this example.

After the server trains both the low-frequency image and the high-frequency image at the K resolutions, Σ_{Q=1}^{K} S_{Q} low-frequency generators and Σ_{Q=1}^{K} W_{Q} high-frequency generators are obtained. The Σ_{Q=1}^{K} S_{Q} low-frequency generators herein are the first generator, and the Σ_{Q=1}^{K} W_{Q} high-frequency generators herein are the second generator.

It should be noted that there is no necessary execution sequence between step S502 and step S503. Step S502 may be performed first, or step S503 may be performed first. Details are not described herein again.

S504: The server separately inputs the target vector to the first generator and the second generator to correspondingly generate a first sub-image and a second sub-image.

In a specific embodiment, after the first generator and the second generator are obtained, when a high-quality image needs to be generated, the server separately inputs the target vector to the first generator and the second generator. The target vector may be a random noise variable obtained by the server from external input or generated by the server, may include output information of another generator, or may be a specific variable that includes image feature information that needs to be generated. Specifically, for example, the original image includes a plurality of scenery images in reality. If the target vector is the random noise variable, a finally output target image may be a synthesized image whose style is similar to that of the original image. If the target vector includes the image feature information that needs to be generated (for example, an image element needs to include mountains and contour information of the mountains), the finally output target image may be a synthesized image that includes the image feature information and whose style is similar to that of the original image.

It should be noted that, because the first generator is obtained through training by using the low-frequency image as the training sample, and the second generator is obtained through training by using the high-frequency image as the training sample, the first sub-image generated by using the first generator is still a low-frequency image, and the second sub-image generated by using the second generator is still a high-frequency image.

S505: The server synthesizes the first sub-image and the second sub-image to obtain a target image.

In a specific embodiment, after obtaining the first sub-image and the second sub-image, the server synthesizes the first sub-image and the second sub-image to obtain the target image. When synthesis is performed, a plurality of methods may be specifically used. Specifically, for example, inverse wavelet transform processing, inverse Fourier transform processing, and inverse discrete cosine transform processing are performed. Specifically, the foregoing means for synthesizing the first sub-image and the second sub-image are common technical means in the conventional technology, and details are not described in this embodiment.

It can be learned from the foregoing technical solutions that embodiments of this application have the following advantages:

After obtaining the first generator and the second generator through training, the server separately inputs the target vector to the first generator and the second generator to correspondingly generate the first sub-image and the second sub-image. Then, the first sub-image and the second sub-image are synthesized to obtain the target image. Because the first generator is obtained by training the initially-configured first GAN in advance by using the first random noise variable and the low-frequency image, and the second generator is obtained by training the initially-configured second GAN in advance by using the second random noise variable and the high-frequency image, the correspondingly generated first sub-image and second sub-image are also the low-frequency image and the high-frequency image respectively. It should be noted that, based on definition of a frequency of an image, the high-frequency image may better reflect detail information of the image, for example, contour information of each subject feature in the image, and low-frequency image may better reflect main information of the image, for example, information such as a grayscale and a color of the image. In the solutions, the low-frequency image and the high-frequency image are separately generated, so that detail information and main information of the to-be-generated target image can be better retained in a process of generating the target image. In this way, better quality of the generated target image is ensured.

In the schematic diagram of the embodiment shown in FIG. 5, the solutions are briefly described. The following uses a specific application for description.

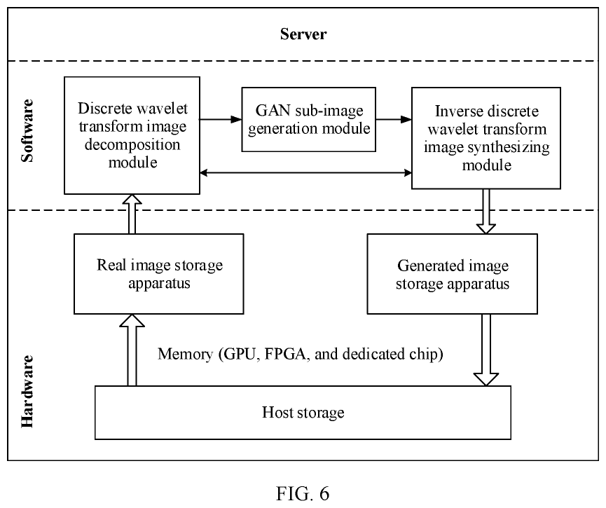

FIG. 6 is a schematic diagram of an embodiment of a system architecture according to an embodiment of this application. As shown in FIG. 6, in a specific embodiment, the server may be divided into a software part and a hardware part. The software part is program code that is included in an AI data storage system and that is deployed on hardware of the server. The program code may include a discrete wavelet transform image decomposition module, a GAN sub-image generation module, and an inverse discrete wavelet transform image synthesizing module. The hardware part includes a host storage and a memory (including a GPU, an FPGA, and a dedicated chip). The host storage specifically includes a real image storage apparatus and a generated image storage apparatus.

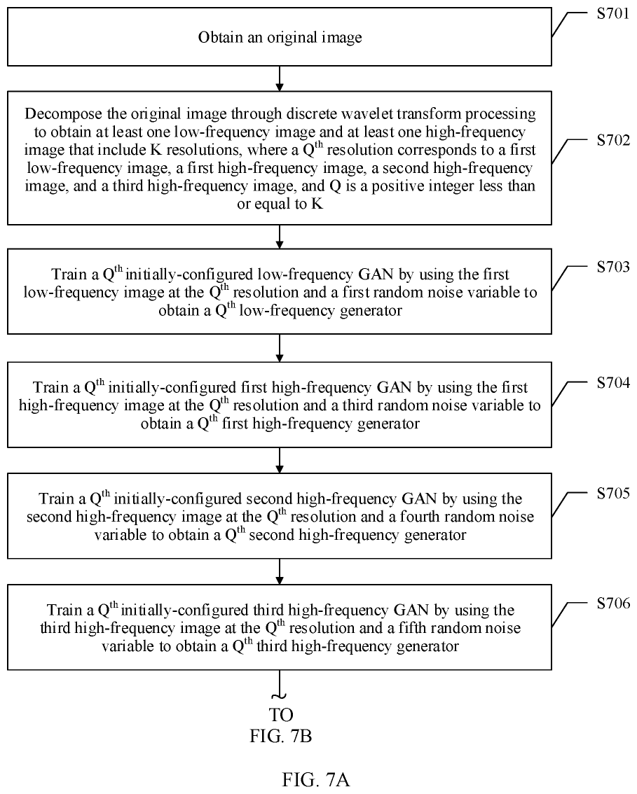

Based on the system architecture in FIG. 6, refer to FIG. 7A and FIG. 7B in the following. FIG. 7A and FIG. 7B are a schematic diagram of another embodiment of an image generation method according to an embodiment of this application. The method may include the following steps:

S701: The server obtains the original image.

In this embodiment, the server may obtain the original image from external input, and store the original image in the real image storage apparatus in the host storage.

S702: The server decomposes the original image through discrete wavelet transform processing to obtain the at least one low-frequency image and the at least one high-frequency image that include the K resolutions. The Q^{th} resolution corresponds to a first low-frequency image, a first high-frequency image, a second high-frequency image, and a third high-frequency image. The first low-frequency image includes low-frequency information of the original image in a vertical direction and a horizontal direction, the first high-frequency image includes low-frequency information of the original image in the vertical direction and high-frequency information of the original image in the horizontal direction, the second high-frequency image includes high-frequency information of the original image in the vertical direction and low-frequency information of the original image in the horizontal direction, and the third high-frequency image includes high-frequency information of the original image in the vertical direction and high-frequency information of the original image in the horizontal direction. Q=1, 2, 3, . . . , or K.

In a specific embodiment, after obtaining the original image, the server stores the original image in the real image storage apparatus, and decomposes the original image by using the discrete wavelet transform image decomposition module. After one original image is decomposed, the at least one low-frequency image and the at least one high-frequency image that are at the K resolutions may be obtained. Each of the K resolutions corresponds to a first low-frequency image, a first high-frequency image, a second high-frequency image, a third high-frequency image, and a fourth high-frequency image. Specifically, for a decomposition process, refer to the following description.

Discrete wavelet transform may be represented as a tree that includes a low-pass filter and a high-pass filter. A matrix representation form of an image is x[2m, 2n], where 2m is a height and 2n is a width of the image. A two-dimensional discrete wavelet decomposition process of the image may be described as follows:

First, one-dimensional wavelet transform (TD-DWT) processing is performed on each row of the original image according to the following formula (1) and formula (2). g[k] is a low-pass filter that filters out a high-frequency part of an input signal and outputs a low-frequency part, and h[k] is a high-pass filter that filters out the low-frequency part of the input signal and outputs high-frequency information, to obtain a low-frequency component L and a high-frequency component H of the original image in a horizontal direction; and k indicates a size of a filter window. The formulas (1) and (2) are as follows:

L[2m,n]=Σₖ₌₀^{K-1}x[2m,2n−k]g[k] (1); and

H[2m,n]=Σₖ₌₀^{K-1}x[2m,2n−k]h[k] (2).

Then, as shown in formulas (3) to (6), 1D-DWT is further performed on each column of the low-frequency component L and the high-frequency component H of the original image in the horizontal direction, to obtain a low-frequency component LL of the original image in the horizontal direction and the vertical direction, namely, the first low-frequency image, a high-frequency component HL of the original image in the horizontal direction and a low-frequency component HL of the original image in the vertical direction, namely, the first high-frequency image, a low-frequency component LH of the original image in the horizontal direction and a high-frequency component LH of the original image in the vertical direction, namely, the second high-frequency image, and a high-frequency component HH of the original image in the horizontal direction and the vertical direction, name, the third high-frequency image. The formulas (3) to (6) are as follows:

LL[m,n]=Σₖ₌₀^{K-1}L[2m−k,n]g[k] (3);

HL[m,n]=Σₖ₌₀^{K-1}H[2m−k,n]g[k] (4);

LH[m,n]=Σₖ₌₀^{K-1}L[2m−k,n]h[k] (5); and

HH[m,n]=Σₖ₌₀^{K-1}H[2m−k,n]h[k] (6).

When the original image is decomposed through discrete wavelet transform, resolutions of the generated low-frequency image and the generated high-frequency image may be further controlled.

S703: The server trains a Q^{th} initially-configured low-frequency GAN by using the first low-frequency image at the Q^{th} resolution and the first random noise variable to obtain a Q^{th} low-frequency generator.

In a specific embodiment, the server obtains the first low-frequency image at the Q^{th} resolution and the first random noise variable, and trains the Q^{th} low-frequency GAN by using the first low-frequency image and the first random noise variable to obtain the Q^{th} low-frequency generator. Specifically, for a training process, refer to related description of step S203 shown in FIG. 2. Details are not described herein again.

S704: The server trains a Q^{th} initially-configured first high-frequency GAN by using the first high-frequency image at the Q^{th} resolution and a third random noise variable to obtain a Q^{th} first high-frequency generator.

In a specific embodiment, the server obtains the first high-frequency image at the Q^{th} resolution and the third random noise variable, and trains the Q^{th} first high-frequency GAN by using the first high-frequency image and the third random noise variable to obtain the Q^{th} first high-frequency generator. Specifically, for a training process, refer to related description of step S203 shown in FIG. 2. Details are not described herein again.

S705: The server trains a Q^{th} initially-configured second high-frequency GAN by using the second high-frequency image at the Q^{th} resolution and a fourth random noise variable to obtain a Q^{th} second high-frequency generator.

In a specific embodiment, the server obtains the second high-frequency image at the Q^{th} resolution and the fourth random noise variable, and trains the Q^{th} second high-frequency GAN by using the second high-frequency image and the fourth random noise variable to obtain the Q^{th} second high-frequency generator. Specifically, for a training process, refer to related description of step S203 shown in FIG. 2. Details are not described herein again.

S706: The server trains a Q^{th} initially-configured third high-frequency GAN by using the third high-frequency image at the Q^{th} resolution and a fifth random noise variable to obtain a Q^{th} third high-frequency generator.

In a specific embodiment, the server obtains the third high-frequency image at the Q^{th} resolution and the fifth random noise variable, and trains the Q^{th} third high-frequency GAN by using the third high-frequency image and the fifth random noise variable to obtain the Q^{th} third high-frequency generator. Specifically, for a training process, refer to related description of step S203 shown in FIG. 2. Details are not described herein again.

It should be noted that, in a process of training a generator in steps S703 to S706, output of any one or more other generators may be further used as input to a currently trained generator.

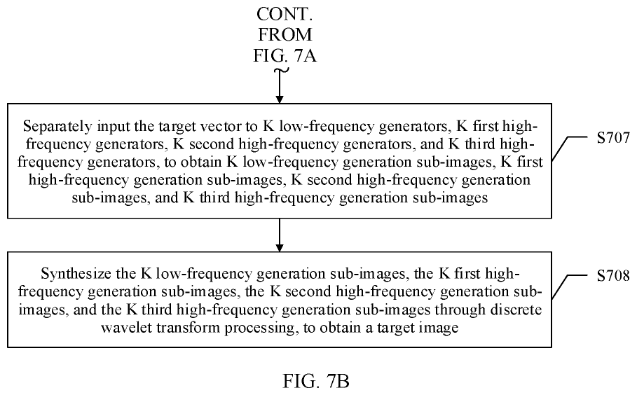

In a specific embodiment, FIG. 8 shows a schematic diagram of a system architecture of the low-frequency GAN, the first high-frequency GAN, the second high-frequency GAN, and the third high-frequency GAN at a determined resolution. As shown in FIG. 8, G1 and D1 are a generator and a discriminator of the low-frequency GAN respectively, G2 and D2 are a generator and a discriminator of the first high-frequency GAN respectively, G3 and D3 are a generator and a discriminator of the second high-frequency GAN respectively, and G4 and D4 are a generator and a discriminator of the third high-frequency GAN respectively. After obtaining the original image, the server obtains a corresponding real image feature by using a VGG19 network module. The VGG19 is a type of the convolutional neural network.

S707: The server separately inputs the target vector to K low-frequency generators, K first high-frequency generators, K second high-frequency generators, and K third high-frequency generators, to obtain K low-frequency generation sub-images, K first high-frequency generation sub-images, K second high-frequency generation sub-images, and K third high-frequency generation sub-images.

In a specific embodiment, after obtaining the K low-frequency generators, the K first high-frequency generators, the K second high-frequency generators, and the K third high-frequency generators, the server separately inputs the target vector to each generator, to correspondingly generate the K low-frequency generation sub-images, the K first high-frequency generation sub-images, the K second high-frequency generation sub-images, and the K third high-frequency generation sub-images. Image parameters (a resolution and a frequency) of each correspondingly generated sub-image are consistent with parameters for a training sample of the generator.

S708: The server synthesizes the K low-frequency generation sub-images, the K first high-frequency generation sub-images, the K second high-frequency generation sub-images, and the K third high-frequency generation sub-images through discrete wavelet transform processing, to obtain the target image.

In a specific embodiment, the server generates the K low-frequency generation sub-images, the K first high-frequency generation sub-images, the K second high-frequency generation sub-images, and the K third high-frequency generation sub-images, and synthesizes the generated sub-images to obtain the target image.

It can be learned from the foregoing technical solutions that embodiments of this application have the following advantages:

After obtaining the K first generators, the K first high-frequency generators, the K second high-frequency generators, and the K third high-frequency generators through training, the server separately inputs the target vector to the K first generators, the K first high-frequency generators, the K second high-frequency generators, and the K third high-frequency generators, to correspondingly generate the K low-frequency generation sub-images, the K first high-frequency generation sub-images, the K second high-frequency generation sub-images, and the K third high-frequency generation sub-images. Then, the K low-frequency generation sub-images, the K first high-frequency generation sub-images, the K second high-frequency generation sub-images, and the K third high-frequency generation sub-images are synthesized to obtain the target image.

It should be noted that the generators are not independent, output of each generator may be used as input to another generator, and the generators are cyclically connected in series. Therefore, quality of images generated by the combined generators is better.

Because the K first generators, the K first high-frequency generators, the K second high-frequency generators, and the K third high-frequency generators are all obtained through training by using images corresponding to different resolutions and different frequencies as training samples, resolutions and frequencies of the correspondingly generated K low-frequency generation sub-images, K first high-frequency generation sub-images, K second high-frequency generation sub-images, and K third high-frequency generation sub-images are also different. In other words, the sub-images carry information mainly expressed by different image parameters. Therefore, when the target image is generated, detail information and main information of the target image can be better retained, and quality of the generated image is improved.

Further, the target image is superimposed on an image generated by another generator to obtain a final target image, and superposition may be a weighted combination. It should be noted that the another generator may be any generator in the conventional technology, and the generator also participates in a training process. A weight adjustment factor α can be self-learned based on a dataset, and a value of a varies depending on different datasets in different scenarios.

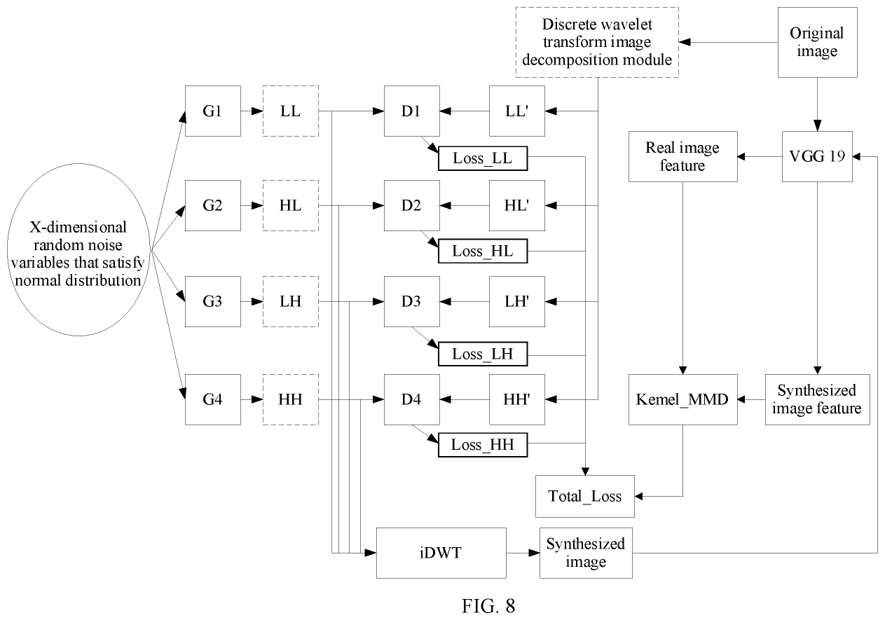

FIG. 9 is a schematic diagram of an embodiment of a server according to an embodiment of this application. The server includes: a transceiver unit 901, configured to obtain a target vector; and a processing unit 902, configured to: separately input the target vector to a first generator and a second generator to correspondingly generate a first sub-image and a second sub-image, where the first generator is obtained by the server by training, based on a low-frequency image and a first random noise variable that satisfies normal distribution, an initially-configured first generative adversarial network GAN, the second generator is obtained by the server by training, based on a high-frequency image and a second random noise variable that satisfies normal distribution, an initially-configured second generative adversarial network GAN, and a frequency of the low-frequency image is lower than a frequency of the high-frequency image; and synthesize the first sub-image and the second sub-image to obtain a target image.

It should be noted that a quantity of first random noise variables and a quantity of second random noise variables correspond to a quantity of first generators and a quantity of second generators respectively. However, the random noise variables need to be orthogonal, and a specific orthogonalization technology is required to make the random noise variables orthogonal.

In a specific embodiment, the transceiver unit 901 is further configured to obtain the low-frequency image, the high-frequency image, the first random noise variable, and the second random noise variable; and the processing unit 902 is further configured to: set the low-frequency image and the high-frequency image as training samples of the first GAN and the second GAN respectively, train the first GAN by using the low-frequency image and the first random noise variable to obtain the first generator, and train the second GAN by using the high-frequency image and the second random noise variable to obtain the second generator.

It should be noted that the generators of the first GAN and the second GAN are connected in series. To be specific, output of the generator of the first GAN is combined with the second random noise variable, and is used as input to the second generator; and vice versa. A combination manner is not limited herein.

In a specific embodiment, the transceiver unit 901 is specifically configured to obtain an original image; and the processing unit 902 is specifically configured to: perform wavelet transform processing on the original image to obtain the low-frequency image and the high-frequency image, and synthesize the first sub-image and the second sub-image through inverse wavelet transform processing to obtain the target image.

In a specific embodiment, the processing unit 902 is specifically configured to: perform discrete wavelet transform processing on the original image to obtain at least one low-frequency image and at least one high-frequency image that include K resolutions, where a Q^{th} resolution corresponds to M_{Q} low-frequency images and N_{Q} high-frequency images, K, M_{Q}, and N_{Q} are all positive integers, and Q=1, 2, 3, . . . , or K; train a Q^{th} initially-configured low-frequency GAN by using the M_{Q} low-frequency images at the Q^{th} resolution and the first random noise variable to obtain a Q^{th} low-frequency generator; train a Q^{th} initially-configured high-frequency GAN by using the N_{Q} high-frequency images at the Q^{th} resolution and the second random noise variable to obtain a Q^{th} high-frequency generator; separately input the target vector to K low-frequency generators and K high-frequency generators to obtain K low-frequency generation sub-images and K high-frequency generation sub-images; and synthesize the K low-frequency generation sub-images and the K high-frequency generation sub-images through inverse discrete wavelet transform processing to obtain the target image.

It should be noted that, at each resolution, input to each generator may be combined by a random noise and output of another generator. In addition, the random noises are orthogonal to each other.

In a specific embodiment, the M_{Q} low-frequency images include a first low-frequency image, and the N_{Q} high-frequency images include a first high-frequency image, a second high-frequency image, and a third high-frequency image. The first low-frequency image includes low-frequency information of the original image in a vertical direction and a horizontal direction, the first high-frequency image includes low-frequency information of the original image in the vertical direction and high-frequency information of the original image in the horizontal direction, the second high-frequency image includes high-frequency information of the original image in the vertical direction and low-frequency information of the original image in the horizontal direction, and the third high-frequency image includes high-frequency information of the original image in the vertical direction and high-frequency information of the original image in the horizontal direction.

The processing unit 902 is specifically configured to: train a Q^{th} initially-configured first high-frequency GAN by using the first high-frequency image at the Q^{th} resolution and the second random noise variable to obtain a Q^{th} first high-frequency generator; train a Q^{th} second initially-configured high-frequency GAN by using the second high-frequency image at the Q^{th} resolution and the second random noise variable to obtain a Q^{th} second high-frequency generator; and train a Q^{th} initially-configured third high-frequency GAN by using the third high-frequency image at the Q^{th} resolution and the second random noise variable to obtain a Q^{th} third high-frequency generator. The processing unit 902 is specifically configured to: separately input the target vector to K low-frequency generators, K first high-frequency generators, K second high-frequency generators, and K third high-frequency generators, to obtain K low-frequency generation sub-images, K first high-frequency generation sub-images, K second high-frequency generation sub-images, and K third high-frequency generation sub-images; and synthesize the K low-frequency generation sub-images, the K first high-frequency generation sub-images, the K second high-frequency generation sub-images, and the K third high-frequency generation sub-images through discrete wavelet transform processing, to obtain the target image.

In a specific embodiment, the transceiver unit 901 is specifically configured to obtain an original image; and the processing unit 902 is specifically configured to: perform discrete cosine transform processing on the original image to obtain the low-frequency image and the high-frequency image, and synthesize the first sub-image and the second sub-image through discrete cosine transform processing to obtain the target image.

In a specific embodiment, the transceiver unit 901 is specifically configured to obtain an original image; and the processing unit 902 is specifically configured to: perform Fourier transform processing on the original image to obtain the low-frequency image and the high-frequency image, and synthesize the first sub-image and the second sub-image through Fourier transform processing to obtain the target image.

Further, the apparatus may further include a superimposition unit, where the superimposition unit is configured to superimpose the target image on an image generated by another generator to obtain a final target image, and superimposition may be a weighted combination. It should be noted that the another generator may be any generator in the conventional technology, and the generator also participates in a training process. A weight adjustment factor α can be self-learned based on a dataset, and a value of a varies depending on different datasets in different scenarios.

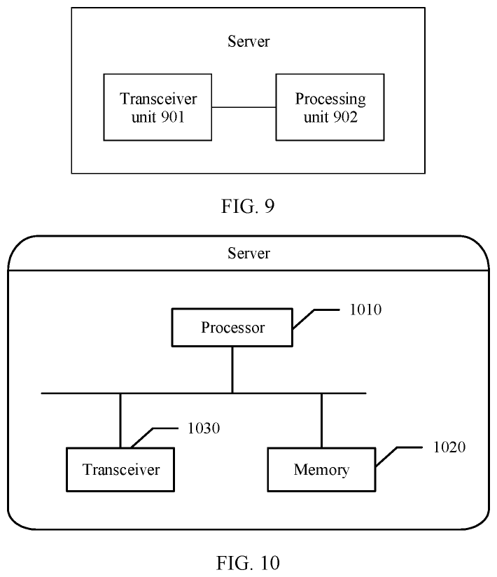

FIG. 10 is a schematic diagram of another embodiment of a server according to an embodiment of this application. The server includes: a processor 1010, a memory 1020, and a transceiver 1030, where the transceiver 1030 is configured to communicate with an apparatus other than the server; the memory 1020 is configured to store instruction code; and the processor 1010 is configured to execute the instruction code, so that the server performs the method in any one of embodiments shown in FIG. 5 or FIG. 7A and FIG. 7B.

An embodiment of this application further provides a computer storage medium. The medium stores instructions, and when the instructions are run on a computer, the computer is enabled to perform the method in any one of embodiments shown in FIG. 5 or FIG. 7A and FIG. 7B.

An embodiment of this application further provides a computer program product. The computer program product includes instructions; and when the instructions are run on a computer, the computer is enabled to perform the method in any one of embodiments shown in FIG. 5 or FIG. 7A and FIG. 7B.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer readable storage medium. Based on such an understanding, the technical solutions of this application essentially, or the part contributing to the conventional technology, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of embodiments of this application.

1. An image generation method, comprising:
obtaining a target vector;
separately inputting the target vector to a first generator and a second generator to correspondingly generate a first sub-image and a second sub-image, wherein the first generator is obtained by a server by training, based on a low-frequency image and a first random noise variable that satisfies normal distribution, a first generative adversarial network (GAN), the second generator is obtained by the server by training, based on a high-frequency image and a second random noise variable that satisfies the normal distribution, a second GAN, and a frequency of the low-frequency image is lower than a frequency of the high-frequency image; and
synthesizing the first sub-image and the second sub-image to obtain a target image.

2. The method according to claim 1, wherein the method further comprises:
obtaining the low-frequency image and the high-frequency image;
obtaining the first random noise variable and the second random noise variable;
setting the low-frequency image and the high-frequency image as training samples of the first GAN and the second GAN respectively;
training the first GAN by using the low-frequency image and the first random noise variable to obtain the first generator; and
training the second GAN by using the high-frequency image and the second random noise variable to obtain the second generator.

3. The method according to claim 2, wherein:
the obtaining the low-frequency image and the high-frequency image comprises:
obtaining an original image; and
performing wavelet transform processing on the original image to obtain the low-frequency image and the high-frequency image; and
the synthesizing the first sub-image and the second sub-image to obtain a target image comprises:
synthesizing the first sub-image and the second sub-image through inverse wavelet transform processing to obtain the target image.

4. The method according to claim 2, wherein the first random noise variable and the second random noise variable are orthogonal.

5. The method according to claim 2, wherein the method further comprises:
obtaining an original image; and
performing discrete cosine transform processing on the original image to obtain the low-frequency image and the high-frequency image, wherein the synthesizing the first sub-image and the second sub-image to obtain a target image comprises:
synthesizing the first sub-image and the second sub-image through inverse discrete cosine transform processing to obtain the target image.

6. The method according to claim 2, wherein the method further comprises:
obtaining an original image; and
performing Fourier transform processing on the original image to obtain the low-frequency image and the high-frequency image, wherein the synthesizing the first sub-image and the second sub-image to obtain a target image comprises:
synthesizing the first sub-image and the second sub-image through Fourier transform processing to obtain the target image.

7. The method according to claim 1 wherein the method further comprises:
superimposing the target image on an image generated by another generator to obtain a final target image.

8. A computer, comprising:
at least one processor; and
one or more memories coupled to the at least one processor and storing programming instructions for execution by the at least one processor to perform operations comprising:
obtaining a target vector;
separately inputting the target vector to a first generator and a second generator to correspondingly generate a first sub-image and a second sub-image, wherein the first generator is obtained by a server by training, based on a low-frequency image and a first random noise variable that satisfies normal distribution, a first generative adversarial network (GAN), the second generator is obtained by the server by training, based on a high-frequency image and a second random noise variable that satisfies the normal distribution, a second GAN, and a frequency of the low-frequency image is lower than a frequency of the high-frequency image; and
synthesizing the first sub-image and the second sub-image to obtain a target image.

9. The computer according to claim 8, wherein the operations comprise:
obtaining the low-frequency image and the high-frequency image;
obtaining the first random noise variable and the second random noise variable;
setting the low-frequency image and the high-frequency image as training samples of the first GAN and the second GAN respectively;
training the first GAN by using the low-frequency image and the first random noise variable to obtain the first generator; and
training the second GAN by using the high-frequency image and the second random noise variable to obtain the second generator.

10. The computer according to claim 9, wherein:
the obtaining the low-frequency image and the high-frequency image comprises:
obtaining an original image; and
performing wavelet transform processing on the original image to obtain the low-frequency image and the high-frequency image; and
the synthesizing the first sub-image and the second sub-image to obtain a target image comprises:
synthesizing the first sub-image and the second sub-image through inverse wavelet transform processing to obtain the target image.

11. The computer according to claim 9, wherein the first random noise variable and the second random noise variable are orthogonal.

12. The computer according to claim 9, wherein the operations comprise:
obtaining an original image; and
performing discrete cosine transform processing on the original image to obtain the low-frequency image and the high-frequency image, wherein the synthesizing the first sub-image and the second sub-image to obtain a target image comprises:
synthesizing the first sub-image and the second sub-image through inverse discrete cosine transform processing to obtain the target image.

13. The computer according to claim 9, wherein the operations comprise:
obtaining an original image; and
performing Fourier transform processing on the original image to obtain the low-frequency image and the high-frequency image, wherein the synthesizing the first sub-image and the second sub-image to obtain a target image comprises:
synthesizing the first sub-image and the second sub-image through Fourier transform processing to obtain the target image.

14. The computer according to claim 8 wherein the operations further comprise:
superimposing the target image on an image generated by another generator to obtain a final target image.

15. A computer-readable storage medium, storing one or more instructions that, when executed by at least one processor, cause the at least one processor to:
obtain a target vector;
separately input the target vector to a first generator and a second generator to correspondingly generate a first sub-image and a second sub-image, wherein the first generator is obtained by a server by training, based on a low-frequency image and a first random noise variable that satisfies normal distribution, a first generative adversarial network (GAN), the second generator is obtained by the server by training, based on a high-frequency image and a second random noise variable that satisfies the normal distribution, a second GAN, and a frequency of the low-frequency image is lower than a frequency of the high-frequency image; and
synthesize the first sub-image and the second sub-image to obtain a target image.

16. The computer-readable storage medium according to claim 15, wherein the one or more instructions, when executed by at least one processor, further cause the at least one processor to:
obtain the low-frequency image and the high-frequency image;
obtain the first random noise variable and the second random noise variable;
set the low-frequency image and the high-frequency image as training samples of the first GAN and the second GAN respectively;
train the first GAN by using the low-frequency image and the first random noise variable to obtain the first generator; and
train the second GAN by using the high-frequency image and the second random noise variable to obtain the second generator.

17. The computer-readable storage medium according to claim 16, wherein:
the obtaining the low-frequency image and the high-frequency image comprises:
obtaining an original image; and
performing wavelet transform processing on the original image to obtain the low-frequency image and the high-frequency image; and
the synthesizing the first sub-image and the second sub-image to obtain a target image comprises:
synthesizing the first sub-image and the second sub-image through inverse wavelet transform processing to obtain the target image.

18. The computer-readable storage medium according to claim 16, wherein the first random noise variable and the second random noise variable are orthogonal.

19. The computer-readable storage medium according to claim 16, wherein the one or more instructions, when executed by at least one processor, further cause the at least one processor to:
obtain an original image; and
perform discrete cosine transform processing on the original image to obtain the low-frequency image and the high-frequency image, wherein the synthesizing the first sub-image and the second sub-image to obtain a target image comprises:
synthesizing the first sub-image and the second sub-image through inverse discrete cosine transform processing to obtain the target image.

20. The computer-readable storage medium according to claim 16, wherein the one or more instructions, when executed by at least one processor, further cause the at least one processor to:
obtain an original image; and
perform Fourier transform processing on the original image to obtain the low-frequency image and the high-frequency image, wherein the synthesizing the first sub-image and the second sub-image to obtain a target image comprises:
synthesizing the first sub-image and the second sub-image through Fourier transform processing to obtain the target image.
